(19) United States
(12) Patent Application Publication
(10) Pub. No.: US 2004/0263969 A1
(43) Pub. Date: Dec. 30, 2004

(54) Lenticular antireflection display

(76) Inventors: Lenny Lipton, Greenbrae, CA (US); William James McKee JR., Tiburon, CA (US)

Correspondence Address: Dergosits & Noah LLP, Suite 1450, Four Embarcadero Center, San Francisco, CA, 94111, US

(21) Appl. No.: 10/722,731

(22) Filed: Nov. 25, 2003

Related U.S. Application Data
(60) Provisional application No. 60/319,728, filed on Nov. 25, 2002.

(51) Int. Cl. G02B 27/22

(52) U.S. Cl. 359/463

(57) ABSTRACT

A lenticular antireflection screen for an electronic display. A lens sheet is arranged in juxtaposition with the display surface of an electronic display. There may or may not be an air gap between the lens sheet and the display surface. The lens sheet has a thickness that is proportional to the pitch of the lenticules. The front surface of the lens sheet includes lenticules oriented at an angle other than 90 degrees relative to a horizontal edge of the lens sheet. The optimum angle for a particular display can be determined by rotating the lens sheet in front of the display and observing when reflections are minimized. In an alternative arrangement, the rear surface of the lens sheet includes concave lenticular elements with a negative diopter power.

### BACKGROUND OF INVENTION

Tens of millions of electronic display screens are in use throughout the world. The outer surface of these displays is a protective cover made of glass or transparent plastic that has a highly reflective surface. When the user of an electronic display looks at information on the screen, he or she does not want to be distracted by reflections off the surface. Thus, over the years, means have been devised for producing surfaces which suppress reflections. One type has been used successfully on both cathode ray tube display screens and flat panel display screens, where a transparent surface on the front surface of the display screen covers the pixel structure or image-forming surface.

In the case of flat panel displays that typically may be a liquid crystal or plasma display, the display surface will be a plane surface. In the case of liquid crystal displays there is a cover sheet that can be made up of plastic or glass. Such a cover sheet should have antireflective properties for optimum performance.

In the case of cathode ray tube display screens, the pixel structure is made of phosphors, usually triads of pixels of red, green, and blue, but the specific construction of the pixels and how they are excited is beyond the scope of this discussion. The same kinds of remarks can be made about flat panel displays, which employ a similar structure. In the case of flat panel displays, the pixel structure is usually a tiled pattern made up of red, green, and blue sub-pixel elements.

For a display screen that has a protective surface in intimate juxtaposition with the pixel structure itself, without an air gap, the outer surface will also be reflective, since some portion of the light rays from the environment will be reflected at the surface of the screen. These surface reflections come from environmental lights such as overhead room illumination or windows. These reflections can be distracting and unpleasant, and interfere with and defeat the purpose of the display itself, namely to convey information.

A new class of display device is gaining currency, namely the plasma panel display, which uses transparent and inadvertently reflective protective sheets, but often there is an air gap between the protective sheet and the display surface.

Generally speaking, two means have been used for the suppression of reflections and these are referred to as antireflection means. When there is no air gap there are two kinds of technologies that are used. One is a textured surface, which leads to a diffusion of the reflections. Such a surface works well. The texture is some kind of a very fine pattern, and rather than reflecting light rays, the light rays are scattered. This art is well known and requires little further elaboration. The reader can think of its properties as analogous to tracing paper. When it is held in intimate juxtaposition with a drawing, one can see the drawing clearly. But when the tracing paper is lifted only a short distance from the drawing, the drawing becomes obscured. The same is true for this textured diffusing surface: if it is not in close proximity to the pixel structure, it will utterly obscure the underlying image.

The next type of antireflection surface is one that is also used in refractive optics, for example, camera lenses. A transparent material of predetermined thickness is coated by one of various means onto the surface of the display screen. This antireflection layer is a quarter of the wavelength of incoming light. A specific wavelength must be selected, and frequently the center of the visible spectrum (green) is selected, at about 550 nanometers wavelength. Various materials have been used, such as magnesium fluoride. There are more complicated approaches that have multiple layers to extend and enhance the antireflection properties of the coating to include more of the visible spectrum. There are other kinds of coatings, but explanation would not enhance understanding of the current invention. With coatings of this kind, a process of destructive interference of light rays within the coating occurs, suppressing the reflected rays and reducing their intensity without affecting the transmission of light through the material itself. This kind of an antireflection surface typically reduces, rather than completely obliterates, the reflections.

Another application for antireflection surfaces is used when the protective sheet is not in close contact with the pixel or image structure. In this case, there is an air gap between the antireflection screen and pixel structure. The antireflection screen has two surfaces, namely a front and a rear surface. The screens are often sold as an add-on product. Such screens cannot use the diffusion method because, as stated before, the image would become blurred. The antireflection quarter-wavelength coating approach may be selected for use on both sides of the protective sheet for the suppression of reflections.

In addition, another means can be employed, i.e., applying a circular polarizer to the inner surface. The retarder component of the circular polarizer faces the display screen, and the linear component of the circular polarizer is in intimate juxtaposition with the surface of the add-on antireflection screen. As is known in the art, circularly polarized light changes handedness when it is reflected. This returning or reflected circularly polarized light will be blocked by the circular polarizer (that now acts as an analyzer).

While such means are effective, the use of antireflection coatings of quarter-wavelength and antireflection surfaces of the circularly polarized kind are expensive. The diffusion approach, which can only be used when the device is in intimate juxtaposition with the pixel structure, is less expensive to manufacture, but cannot be used in applications that require an air gap between it and the image surface.

We will now describe a novel means that is effective for the suppression of reflection from the surface of the display screen even when the antireflection screen has an air gap between it and the display screen. Moreover, the approach is relatively inexpensive to manufacture.

### BRIEF DESCRIPTION OF DRAWINGS

FIG. 1a shows the cross-section of the lenticular antireflection screen that is the subject of this disclosure.

FIG. 1b is a perspective view of the antireflection screen shown in FIG. 1a.

FIG. 2 shows the inventive antireflection screen used in conjunction with an electronic display.

FIG. 3 is a perspective view of an antireflection screen having lenticules on both sides of the screen.

### DETAILED DESCRIPTION OF THE INVENTION

A new means for the suppression of reflections has come from our work with lens sheets or lenticular screens used in conjunction with autostereoscopic electronic displays. We have employed these lens sheets to produce multi-perspective displays. The display screen, since it is in close proximity to the pixel structure of the electronic display, provides image selection means at or near the surface of the display, and by this means, the observer is not required to wear individual selection devices or glasses. Depending upon the focal length of the lenticules, the screen may or may not be in intimate contact with the pixel structure of the display. In other words, the screen may be laid directly onto the display surface or it may be held some distance from that surface with an intervening air gap.

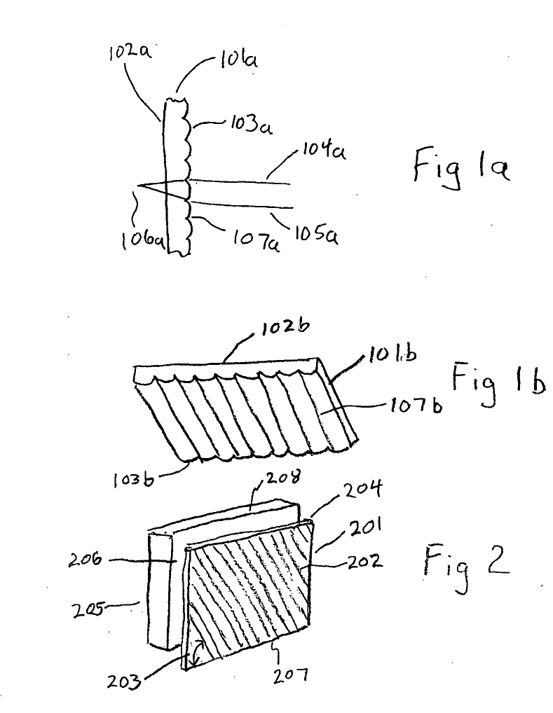

In the course of our work, we have learned that for electronic displays there is a great benefit to using display screens that have an unconventional orientation compared to the usual orientation for a parallax panoramagram. A conventional panoramagram has the boundary axes parallel to the vertical edge of the display (see below and element 107a FIG. 1). However, we tip the boundary axes at some specified angle. Lens sheets which may be used in conjunction with a panoramagram have been described in the art since 1915 in U.S. Pat. No. 1,128,979 by Walter Hess. The display screen of the type with tipped boundary axes is an improvement over Hess and is described in U.S. Pat. No. 3,409,351 to Winnek.

FIG. 1a shows a cross-section of a lenticular sheet. The lens sheet itself is indicated by 101a. 102a is the back of the lens sheet, which is a planar surface. 103a indicates the front surface of the lens sheet. Lens sheets of this type have been thoroughly described in the prior art. The outer surface resembles corduroy or the surface of a washtub. The cross-section here is meant to indicate that the lens sheet is made of optical elements that are circular arc sections, such as transparent refractive glass or plastic. However, higher power surfaces, such as elliptical or paraboloid, or other types of surfaces, such as prismatic surfaces with a triangular cross-section, can be used. A lens sheet can be thought of as a series of cylinders that have been fused together and whose back surface has been sliced off to produce a plane.

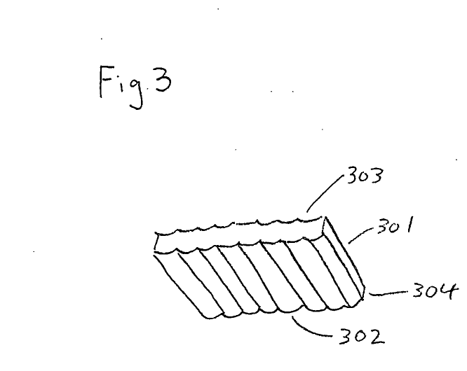

Elements 104a and 105a are incoming rays of light that are refracted by the lenticular sheet because of the curved nature of surface 103a, to reach a focal point at 106a. (The various focal points of the individual lenticules describe the surface of a focal plane). 107a is the boundary axis or intersection between the curved surfaces that form a straight line. The straight-line boundary axes can be seen clearly in the perspective view of the lens sheet in FIG. 1b, as depicted by 107b. The lens sheet 101b has a plane surface 102b and a refractive surface 103b. FIG. 2 shows a lens sheet 201 used in conjunction with an electronic display module 205 whose front imaging surface is 206. The front surface is transparent and covers or protects the pixel structure. The boundary between the lenticules, which we call the boundary axes (the boundary axis being depicted in FIG. 1a and FIGS. 1b by 107a and 107b respectively), is indicated in FIG. 2 by 202. 204 is the thickness of the lens sheet itself. The angle between the boundary axes and the horizontal edge of the lens sheet is indicated by 203, which we call angle ω (omega). It is assumed that the display module itself has a rectangular shape with right angle edges, and that the same condition is applied to the lens sheet. For example, it should be clear to the reader that when ω=90 degrees, the boundary axes of the lens sheet 202 will be at right angles to the horizontal edge of the lens sheet 207, and thus to the horizontal edge of the electronic display. The horizontal edges are depicted by two surfaces, one for the lens sheet 207 and one for the display 208.

In the course of our work, we have discovered a surprising and previously unobserved phenomenon. A lens sheet of the type that we described in FIG. 2, with ω set to some value other than 90 degrees, will produce, depending upon the value of ω, a strong antireflective effect. This may seem surprising to workers who are familiar with the art, and it is the paradoxical nature of this phenomenon that may have led others to ignore it. In the classic panoramagram, ω is 90 degrees, and the surface of a lens sheet produces annoying and distracting reflections that usually appear as horizontal bands. These horizontal reflections are one of the problems associated with lens sheets for autostereoscopic displays. One way to treat this problem, which we have never seen employed, is to coat the surface of the lenticular screen with a quarter-wave antireflective surface. In theory, this should work well, but would add substantially to the cost of the lens sheet. Texturing the lens sheet for antireflective diffusion properties would ruin the effectiveness of the lens sheet by destroying its refractive properties.

The kinds of lens sheets we have employed have circular lenticules (the lenticules being the individual elements making up the lens sheet, each individual element being separated by a boundary axis 107b), and are usually figured to have a focal point 106a that is at or near the pixel elements of the display surface.

For the particular kinds of electronic displays we have been using, i.e., both liquid crystal displays and plasma panels, we set c at some value other than 90 degrees. Values of ω from 80 to 5 degrees (measured with counterclockwise rotation having a positive value with reference to FIG. 2) can be employed for our purposes to create an autostereoscopic effect. We have observed that at such angles, there is a strong antireflection property, and the surface of the screen casts reflections at directions that are not seen by the observer. In fact, the effect of such an antireflective surface is similar to that of the textured or diffusing screen and is highly effective. An important point is that the lens screen does not need to be in close proximity to the pixel structure of the electronic display module itself, and a air gap may exist between the two. This is advantageous because such a lenticular antireflective screen can be an add-on product. Since it does not need to be in contact with the surface of the display, and there can be an air gap between the lens screen and the display surface itself, it works well with plasma display panels, in which the cover protective sheet is usually placed at some distance from the display surface.

The setting of ω itself is one that can be determined by empirical means. One simply rotates an antireflection screen of the design described here in front of the electronic display, and notes when the environmental reflections are redirected benignly and therefore suppressed. In the case of an autostereoscopic application, ω must be set according to stereoscopic considerations, and there can be a surprisingly beneficial result as far as antireflection properties are concerned. In point of fact, it is possible to satisfy the requirements of a good autostereoscopic display and a good antireflection screen.

The finer the pitch, i.e., the smaller the distance between boundary axes, the less obtrusive is the lens sheet structure. Something that is not as obvious is that the focal point 106a (which is related to the focal length of the individual lenticules, which in turn is related to the refractive index of the lens sheet itself) and the specific degree of curvature of the individual lenticules need not be at the surface of the screen. In other words, the focal plane may be in front of or behind the screen.

For the case of an autostereoscopic display, the focal length of the lenticules needs to be brought to a focus at or near the surface of a pixel. The focal length is approximately the distance from the optical center of the individual lenticule to the pixel itself when sharpest focus is achieved. For the case of the lens sheet antireflective application, when an autostereoscopic effect is not desired, the focal point should be in front of or behind the pixel structure. If this is not the case, then fine print and other fine details will be obscured, as has been observed by those familiar with the art. Therefore, if the lens sheet is effectively defocused, then the antireflective properties are maintained, but fine image detail will not be obscured.

The three parameters, namely focal length, ω, and pitch, can all be determined empirically in order to enhance the antireflective properties of the display screen. Moreover, the surface curvature of the lenticules need not be a section of a circle, but can be some other surface, such as a higher power surface, or a sine curve, or a cross-section of a triangle. The surface must be refractive and there are many possibilities for achieving this, only some of which are optimal.

The pitch of the lenticular screen will also determine its thickness for a given surface radius of curvature. If the radius is large (focal plane well before or beyond the information display plane) and the pitch is large, then the screen thickness will necessarily be proportionally thicker to accommodate this large pitch. As the pitch is decreased, the thickness may likewise be reduced. In this case there are some practical limitations in the ability to fabricate the screen and the overall c angle for which it will accept the ambient light and still effectively reflect it away.

FIG. 3 illustrates an alternative approach to the suppression of reflections using lens sheet technology. It does this by using the surface antireflection technique that is described above with the addition of a means for neutralizing the diopter power of the lens sheet 301 of thickness 304. Such an approach is appropriate for non-stereoscopic applications where fine detail must be discerned.

The front surface 302 faces the observer, and the rear surface 303 faces the display. Inner surface 303, which faces the display screen, may be touching the display surface or it may be spaced some distance away with an air gap between the surface 303 and the display screen (not shown). In either case, the concave lenticular surfaces of 303, with a negative diopter power, provide a means to neutralize the focusing properties of the lens sheet front surface 302 that is made up of convex lenticules with a positive diopter. If the sum of the diopter powers of the two surfaces is zero, the net focusing result for rays passing through the sheet will be similar to that which would have occurred had the two surfaces been parallel planes. By this means, only the antireflective function of the lenticules is preserved and the focusing property of the lenticules is suppressed. By this means, the underlying image is not refracted and its image quality is preserved, especially for fine details.

As stated, the motivation for using a lens sheet in contact with the display surface is to neutralize the reflective properties of the front surface to enhance the legibility of fine type, for example. However, in the case of a configuration that employs an air gap the purpose is two fold: to neutralize the focusing properties of the front surface, and also to suppress reflection which may occur at the inner surface.

We have described a technique for suppressing, redirecting and smoothing out the appearance of distracting reflections that appear on the surfaces of a planar electronic display or cover sheet, or, in addition, the lenticular screen employed for autostereoscopic applications. For that matter, the process will work well for other applications, such as the suppression of reflections from the surface of mounted pictures requiring a protective sheet. The process depends on the organizing and redirecting of surface reflections by means of a uniform array of parallel lenticules or similar optical elements. The boundary axes of these elements must be tipped at some angle c to the horizontal, and ω is optimized heuristically.

The process gives a result that is similar in appearance to that achieved by textured surface antireflection means, but in addition, it may be used if an air gap is present between the protective cover sheet and the display surface. The process is considerably less costly to manufacture than the traditional quarter-wave antireflection coating. Glass or plastic sheets may be employed and the lenticules may be made of plastic coated on a glass or plastic substrate. For antireflection purposes, relatively loose manufacturing tolerances may be used with regard to establishing the diopter power of the lenticules, their pitch, and the overall uniformity of the surface(s).

1. A lenticular antireflection display, comprising:
a display surface; and
a lens sheet coupled over the display surface and having a plurality of lenticules disposed thereon, wherein the lenticules are disposed on the lens sheet at an angle other than 90 degrees relative to a horizontal edge of the lens sheet.
